(19) United States
(12) Patent Application Publication
(10) Pub. No.: US 2024/0004770 A1
(43) Pub. Date: Jan. 4, 2024

(54) SCALABLE ANONYMIZED DEFECT SCANNING OF COMPONENTS IN DEPLOYED COMPUTING SYSTEMS

(71) Applicant: Intel Corporation, Santa Clara, CA (US)

(72) Inventors: Rajesh Poornachandran, Portland, OR (US); Kaushik Balasubramanian, Beaverton, OR (US); Karan Puttannaiah, Hillsboro, OR (US)

(73) Assignee: Intel Corporation, Santa Clara, CA (US)

(21) Appl. No.: 17/852,662

(22) Filed: Jun. 29, 2022

(51) Int. Cl. G06F 11/27; G06F 11/07

(52) U.S. Cl. CPC G06F 11/27; G06F 11/0793; G06F 11/0706

(57) ABSTRACT

Managing scan detection of a component in a computing system includes detecting a scan interrupt, reading a scan register of the component, the scan register including a hashed identifier (ID) of the component; getting material vintage information of the component based at least in part on the hashed ID; and initiating a scan of the component based at least in part on the material vintage information to detect any defects in the component.

### FIELD OF THE DISCLOSURE

This disclosure relates generally to detecting defects in components of computing systems, and more particularly, to scalable anonymized defect scanning in components in deployed computing systems.

### BACKGROUND

Public cloud computing environments processing diverse workloads are vulnerable to manufacturing defects arising in components of deployed computing systems of the cloud computing environments. This often results in either user visible system crashes or silent data errors (SDEs). Guaranteeing a fleet uptime by the datacenter operator for users is made difficult by inherent defects (measured by Defects Per Million (DPM)) in manufactured silicon-based components. In many cases, these defects are identified by a datacenter qualification process which determines a correlation between a “vintage” of the failed component and specific manufacturing binning/lot/material vintage characteristics. Some defects result in datacenter operators bringing down the deployed computing systems (such as servers) affected by the defects, causing a significant disruption and/or total cost of ownership (TCO) disadvantage to cloud service providers in terms of system availability and reliability. As part of the silicon manufacturing process changes over time for a given component (e.g., a product such as a processor, memory, interconnect, etc.), there is inherent variability in DPM for some components. Existing technology for screening of defects in “in-field” (deployed) computing systems does not take the vintage of the component into consideration.

### BRIEF DESCRIPTION OF THE DRAWINGS

FIG. 1 illustrates a computing arrangement according to some embodiments.

FIG. 2 is a flow diagram of configuration processing according to some embodiments.

FIGS. 3A and 3B are flow diagrams of operational processing according to some embodiments.

FIG. 4 is a block diagram of an example processor platform structured to execute and/or instantiate the machine-readable instructions and/or operations of FIGS. 2-3 to implement the apparatus discussed with reference to FIG. 1.

FIG. 5 is a block diagram of an example implementation of the processor circuitry of FIG. 4.

FIG. 6 is a block diagram of another example implementation of the processor circuitry of FIG. 4.

FIG. 7 is a block diagram illustrating an example software distribution platform to distribute software such as the example machine readable instructions of FIGS. 2-3 to hardware devices owned and/or operated by third parties.

The figures are not to scale. In general, the same reference numbers will be used throughout the drawing(s) and accompanying written description to refer to the same or like parts.

### DETAILED DESCRIPTION

The technology described herein provides a method and system for detecting defects in components of a computing system that considers the vintage of the components and takes prioritized and/or customized remedial action when defects are detected. The method and system are applicable to large scale cloud computing environments having components comprising heterogeneous intellectual property (IP) blocks from multiple manufacturers and/or vendors. The technology described herein implements decentralized tracking of DPM statistics for one or more levels of a processing core, interconnect, memory, system on a chip (SoC), or other components of computing systems with heterogeneous IP blocks while preserving confidentiality and anonymity.

As used herein “vintage” refers to descriptive information identifying a component of a computing system, such as one or more of wafer material, manufacturing process node, manufacturing process version information, manufacturing bin, manufacturing lot, date of manufacture, time of manufacture, component type, product type, product version, date code of manufacturing, information regarding whether any processing cores are de-featured or all processing cores are enabled, etc. Components of the same vintage have common characteristics and may have similar DPM rates.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and/or other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

As used herein, a computing system can be, for example, a server, a disaggregated server, a personal computer, a workstation, a self-learning machine (e.g., a neural network), a mobile device (e.g., a cell phone, a smart phone, a tablet (such as an iPad™)), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

As used herein, a component of a computing system includes any integrated circuit (IC) providing one or more capabilities of a product such as a processor, a memory, an interconnect, wired communication circuitry, wireless communication circuitry, a system on a chip (SoC), accelerator, integrated graphics circuitry, on-die memory (e.g., high bandwidth memory (HBM)), use case specific on-die accelerators, or any other circuitry in a computing system. In some instances, a component may be referred to as an IP block. A component may include firmware, such as a basic input/output system (BIOS).

In existing deployed computing systems, defective components are identified by in-field testing by technical staff once problems arise. This manual and labor-intensive activity often results in bringing down computing systems (such as servers) and causing significant disruption to large scale cloud computing environments operated by cloud service providers (CSPs). This results in lower fleet utilization of servers and total cost of ownership (TCO) disadvantages and may impact service level agreements (SLAs) with customers.

Many defects tend to be associated with a particular vintage of a component (e.g., a CPU, a GPU, a DSP, an FPGA, an accelerator, a memory component, an interconnect, a wireless modem, and so on), and existing solutions do not have the capability to detect defective components for any in-field remedial action without compromising the reliability, availability and TCO constraints for CSPs. Further, there is no capability to scale defect detection to multiple IP blocks provided by different third-party vendors. Failing components which are sequestered offline may not exhibit the same DPM rate as when the components are deployed in live cloud computing environments, thereby making performing root-cause-analysis even more difficult.

The technology described herein provides a comprehensive solution for performing defect scanning of components (such as heterogenous IP blocks) in deployed computing systems of large-scale cloud computing environments based at least in part on component vintage information. This technology improves the detection and sourcing of defective components, and further takes remedial action at the deployment site in an at-scale deployment model in CSPs, without compromising reliability, availability and TCO constraints. This technology tracks DPM (for example, due to manufacturing changes over time for components) at the processing core/interconnect/memory/SoC level with heterogeneous IP blocks while preserving confidentiality and anonymity.

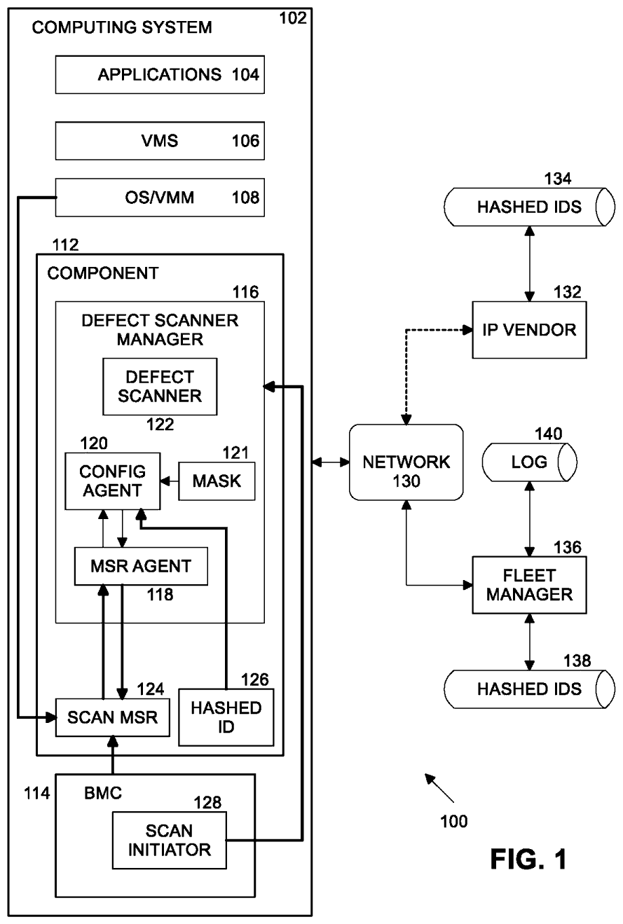

FIG. 1 illustrates a computing arrangement 100 according to some embodiments. At a software level, computing system 102 includes one or more applications 104, one or more virtual machines (VMs) 106, an operating system (OS) and a virtual machine manager (VMM) 108 as is well known. At a hardware level, computing system 102 includes one or more components 112. In an embodiment, component 112 comprises one or more of an SoC, a CPU, a GPU, an XPU, an FPGA, a DSP, an ASIC, an interconnect, a wireless modem, accelerator, integrated graphics circuitry, on-die memory, and/or other circuitry forming an IP block. In an embodiment, a plurality of components 112 may be designed and/or manufactured by different component vendors. In some computing systems 102, there may be large numbers of components (e.g., tens, hundreds, thousands, etc.).

Computing system 102 includes a baseboard management controller (BMC) to assist in managing the computing system. In one implementation, the functionality of the BMC 114 as described herein may be implemented in a trusted execution environment (TEE). A TEE is a secure area of a processor that guarantees code and data loaded inside the processor are protected with respect to confidentiality and integrity. In an embodiment, the defect scanning initiation capability described herein is performed by a BMC. In another embodiment, the defect scanning initiation capability described herein is performed by code being executed in a TEE. BMC 114 includes a scan initiator 128 to initiate a defect scan of one or more components. For a BMC, the scan initiator is implemented in firmware or circuitry. For a TEE, the scan initiator is implemented in code executed by a processor in a secure computing environment. Scan initiator 128 writes scan model specific register (MSR) 124 of component 112 as described below.

In an embodiment, component 112 includes defect scanner manager 116 to manage the defect scanning process as described herein. In various embodiments, defect scanner manager 116 may be implemented in software, firmware, or circuitry in component 112. Scan initiator 128 directs defect scanner manager 116 to scan at least a portion of component 112 for defects.

Defect scanner manager 116 includes MSR agent 118 to read and write one or more selected MSRs of component 112 (such as scan MSR 124), configuration (config) agent 120 to set up a configuration for defect scanning (including setting up a region of memory (e.g., MCHECK) to hold one or more scan test patterns), and defect scanner 122 to control and/or manage performance of defect scans of at least a portion of component 112. Configuration agent 120 uses one or more masks 121 as part of a defect scan configuration process as described below. Although MSR agent 118, configuration agent 120 and defect scanner 122 are shown in FIG. 1 as separate components of defect scanner manager 116, in another embodiment these components may be combined into a single firmware object or single circuit. Configuration agent 120 obtains a hashed ID 126 from circuitry in component 112 to identify vintage details of the SoC and validates the hashed ID.

Although only one computing system is shown for simplicity in FIG. 1, in practice in any given computing environment (such as a large-scale cloud computing environment) there may be any number of computing systems coupled over a network 130 (either a public network such as the Internet or a private network (e.g., an intranet)). For example, the number of computing systems may be in the thousands, tens of thousands, or even hundreds of thousands in a large-scale cloud computing environment operated by a CSP. As can be appreciated, managing performance of defect scanning across large numbers of deployed computing systems in a large-scale cloud computing environment may be challenging.

In an embodiment, component 112 includes scan MSR 124 to store transitory information relating to defect scanning as described herein, and a permanent hashed ID 126 fused into the circuitry of the component during the manufacturing process to identify vintage details of the component. Hashed ID 126 may include one or more of unique CPU ID, unique GPU ID, unique XPU ID, manufacturing details (e.g., bins, lots, material characteristics), vendor-provided unique ID, and optionally vintage information (such as date code of manufacturing, manufacturing bin, and/or manufacturing process version information, etc.) Hashed ID 126 is exposed via scan MSR 124 to in-band software (SW), firmware (FW), or circuitry, such as defect scanner manager 116, that controls application of Scan-At-Field (SAF) test patterns to identify any defects in the component 112. In an embodiment, OS/VMM 108 may also write to scan MSR 124, resulting in defect scanner manager 116 of performing defect scanning of component 112 at the direction of the OS/VMM.

In current computing systems, when a selected component is a CPU, a Protected Processor Inventory Number (PPIN) of the CPU can be obtained using a specific MSR (for example, MSR 0x4f in some CPUs manufactured by Intel Corporation). The PPIN is unique to the selected component and can be used to determine the manufacturing bins and/or lots of the selected component. This is typically fused off in the production BIOS. Furthermore, in current computing systems there is no association of any component (e.g., IP block) with the vintage of the component. A Scan-at-Field (SAF) feature may be used in some computing systems to detect defects, but this is accomplished by manually invoking scan tests (e.g., by a systems administrator or test technician). This is also currently done without being aware of the vintage of the component under test. This can sometimes result in under-testing of components from lots with higher DPM rates. Another issue is unnecessary over-testing of components. Vintage aware testing as provided by the technology described herein helps alleviate both problems. The unique hashed ID 126 in component 112 provides an avenue to address this issue while preserving IP confidentiality and anonymity. This is achieved by the present computing arrangement 100 that includes secure retrieval of the unique hashed ID 126 by configuration agent 120 of defect scanner manager 116 and secure lookup of component vintage at BMC 114, while leveraging the SAF capability for detecting defects.

IP vendor 132 designs, manufacturers, and/or distributes components 112. Although only one IP vendor 132 is shown in FIG. 1, there may be any number of IP vendors providing any number of components to computing system 102. IP vendor 132 stores hashed IDs 134 of components distributed by the IP vendor. When one or more components (e.g., component 112) are deployed in a computing system 102, fleet manager 136 stores the hashed IDs 138 of the deployed components. In an embodiment, fleet manager 136 is operated by a CSP in a cloud computing environment hosting one or more computing systems 102. Fleet manager 136 manages tracking of hashed IDs 138 and associated components 112 in computing system 102. Fleet manager 136 also obtains crowd-sourced information to record DPM statistics and estimated potential future DPM statistics from a fleet of computing systems 102 with multiple components 112 and stores this statistical information in log 140. IP vendor 132 and fleet manager 136 communicate over network 130. In another embodiment, communication between the IP vendor 132 and fleet manager 136 over network 130 is optional. Fleet manager 136 may obtain hashed IDs of deployed components through other (out-of-bounds) means.

Table 1 shows an example format of a scan MSR 124.

TABLE 1

| MSR bits | Description | Comment |
|---|---|---|
| 0 | Scan Interrupt | Default = 0 |
| 1 | Validation Failure | Default = 0 |
| | Indicator | |
| 2-15 | Unique | Number of bits dedicated |
| | Hashed ID | for this value is based on |
| | | implementation choice. |
| 16-31 | Material Vintage | Optional. Provided for cases when |
| | Information | information is store on hardware. |
| | | Defaults to 0s if the information |
| | | is stored at a datacenter managed |
| | | by fleet manger or at an IP vendor site. |
| | | Number of bits dedicated for this |
| | | is based on implementation choice. |

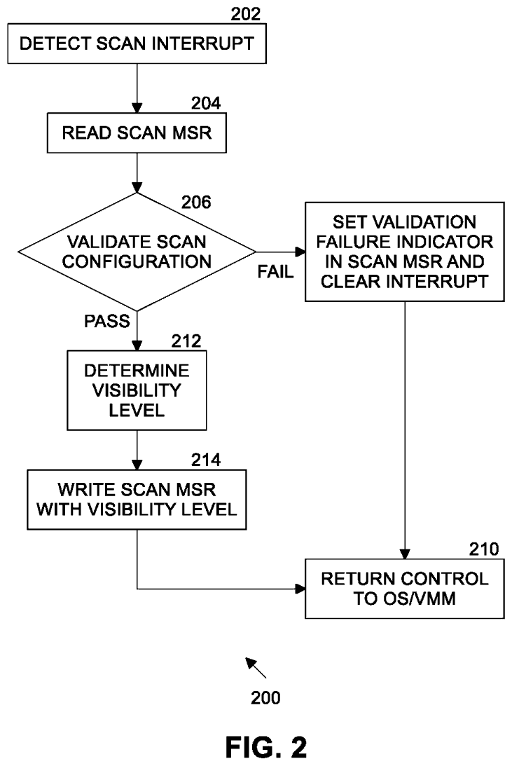

FIG. 2 is a flow diagram of configuration processing 200 according to some embodiments. When scan MSR 124 is written (by either BMC 114 or OS/VMM 108), a scan interrupt is triggered and processing of OS/VMM 108 is interrupted. The scan interrupt is detected at block 202 by MSR agent 118 of defect scanner manager 116. In an embodiment, defect scanner manager 116 handles message signaled interrupts (MSIs) generated by writes to Scan MSR 124. MSR agent 118 reads scan MSR 124 at block 204 to get scan configuration information stored in the scan MSR. For example, MSR agent 118 reads a unique hashed ID and material vintage information. At block 206, configuration agent 120 validates the scan configuration information. In an embodiment, validation includes one or more of determining that the scan configuration information matches the component 112, the scan configuration information has a valid header, loader version, and checksum, and that the scan configuration information is authentic and passes a check of a digital signature.

Embodiments to validate the scan configuration information include examining dedicated MSR bits that are part of scan MSR 124 (e.g., optional material vintage information) and reading a mailbox register (not shown in FIG. 1) in component 112 when a scan is triggered. These can be part of the scan MSR bit fields (e.g., 8 bits each in a 512-bit register for header, version, and 32-bits for checksum/signature) or the scan MSR can point to a mailbox (whereby OS/VMM 108 updates the mailbox prior to triggering the scan interrupt by writing to the scan MSR). MSR Agent 118 validates the checksum.

In an embodiment, matching the scan configuration information to the component comprises comparing the unique hashed ID in scan MSR 124 (written by BMC 114 or OS/VMM 108) to hashed ID 126 (stored in component 112 during manufacturing).

In an embodiment, encryption of hashed ID is an implementation choice. Decryption of an encrypted hash ID may be performed by fleet manager 136 or by IP vendor 132 depending on the implementation.

If any of these validation operations fail, at block 208 MSR agent 118 sets the validation failure indicator field in scan MSR 124, resets the scan interrupt field in scan MSR 124 and returns operational control of computing system 102 to the OS/VMM 108. If all validation operations pass, then at block 212 configuration agent 120 determines, based at least in part on MSI bits set by OS/VMM 108, a visibility level of the unique hashed ID 126 for devices of computing system 102 managed by OS/VMM 108. In an embodiment, the visibility level may be an SoC level, an IP block level, or an interconnect level. In an embodiment, IP vendor 132 of component 112 can decide whether to make the hashed ID 126 be visible local to the component, to an interconnect, or to the computing system 102 level.

BMC 114 at the platform level (e.g., computing system 102) can have visibility information for multiple components. A component 112 may have an internal register fused with visibility configuration during manufacturing. Visibility level determination is based on individual ingredient manufacturer or IP vendor decisions (that is, by implementation choice). This is determined during the manufacturing or provisioning time frame. The visibility level provides hints on what information and to whom the information can be exposed (e.g., only to entities with valid checksum, signature, etc.)

In an embodiment, other configurable policy-based actions may be taken by configuration agent 120, such as reporting to a system administrator about a query, returning a standard response based on the query or origination of the query, returning hash information based on query or origination of the query, etc.

In an embodiment, a visibility level is specific to a component. In an embodiment, only a secure enclave can decrypt hashed ID 126 (if the hashed ID is encrypted). At block 214, MSR agent 118 writes scan MSR 124 by setting the scan interrupt bit and setting the validation failure bit. Example embodiments for visibility of unique hashed ID 126 include BMC 114 at the computing system level can have visibility information for multiple components (such as XPUs) connected to it. Each component (e.g., SoC/IP block, etc.) may have an internal register fused with visibility configuration during the manufacturing process. Processing then clears the scan interrupt field and returns operational control to the OS/VMM 108 at block 210.

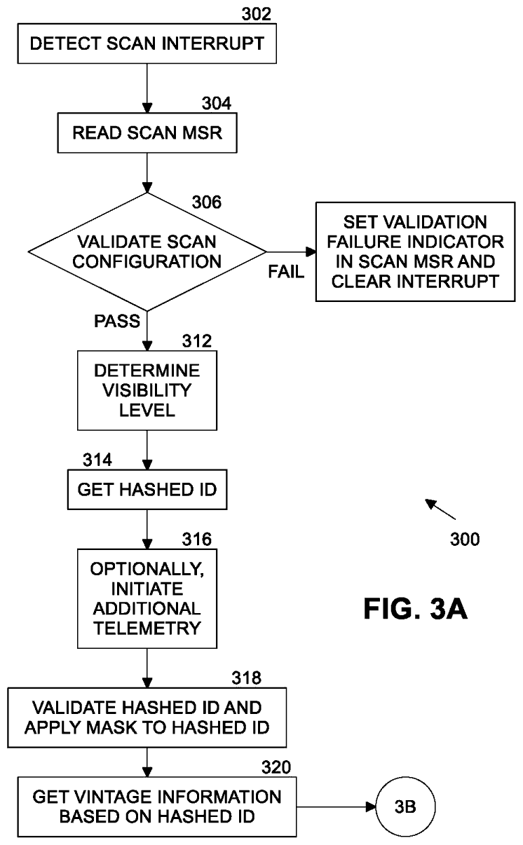

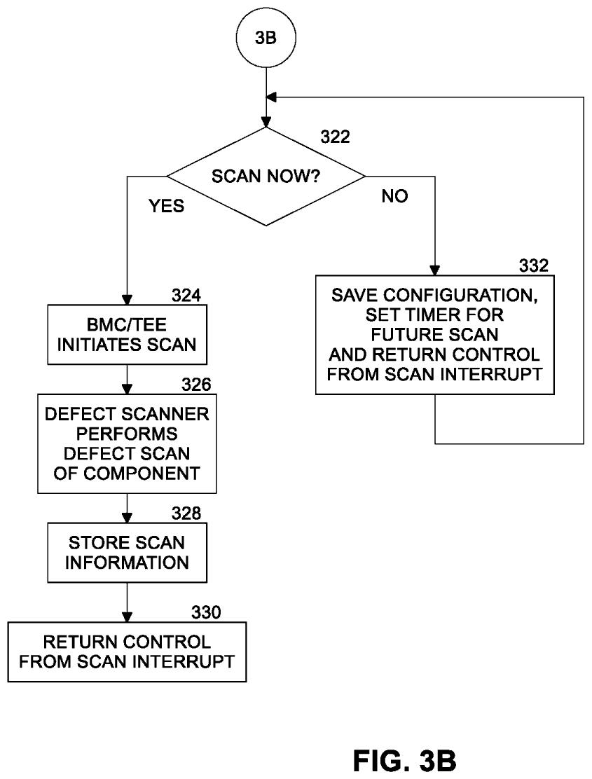

FIGS. 3A and 3B are flow diagrams of operational processing 300 according to some embodiments. When scan MSR 124 is written (by either BMC 114 or OS/VMM 108), a scan interrupt is triggered and processing of OS/VMM 108 is interrupted. The scan interrupt may be initiated by a datacenter administrator manually or automatically based on an implementation choice.

In one embodiment, a mailbox register within a component (such as a IP block or SoC) or BMC 114 may indicate the configuration or operational flow once the generic scan interrupt is triggered. In an embodiment, when the computing system is deployed or hardware changes are made to the computing system, the datacenter system administrator sets the mailbox register to the configuration flow to run the configuration portion (as described in FIG. 2). Once the computing system is being actively used by OS/VMM 108, this mailbox is changed to the operational flow described in FIGS. 3A and 3B based on the requirement.

The scan interrupt is detected at block 302 by MSR agent 118 of defect scanner manager 116. In an embodiment, defect scanner manager 116 handles message signaled interrupts (MSIs) generated by writes to Scan MSR 124. MSR agent 118 reads scan MSR 124 at block 304 to get scan configuration information stored in the scan MSR. In an embodiment, MSR agent 118 reads a unique hashed ID and material vintage information. At block 306, configuration agent 120 validates the scan configuration information. In an embodiment, validation includes one or more of determining that the scan configuration information matches the component 112, the scan configuration information has a valid header, loader version, and checksum, and that the scan configuration information is authentic and passes a check of a digital signature.

In an embodiment, matching the scan configuration information to the component comprises validating the interrupt requesting the scan by comparing the checksum of the request to the checksum in scan MSR 124. The checksum in scan MSR 124 is fused in circuitry component 112 during manufacturing or written by BMC 114 or OS/VMM 108.

If any of these validation operations fail, at block 308 MSR agent 118 sets the validation failure indicator field in scan MSR 124, resets the scan interrupt field in scan MSR 124 and returns operational control of computing system 102 to the OS/VMM 108. If all validation operations pass, then at block 312 configuration agent 120 determines, based at least in part on MSI bits set by OS/VMM 108, a visibility level of the unique hashed ID 126 for devices of computing system 102 managed by OS/VMM 108. At block 314, configuration agent 120 gets the hashed ID 126 and clears the scan interrupt field in scan MSR 124. In an embodiment, BMC 114 may, optionally, initiate additional telemetry collection during a Scan-At-Field test run to characterize the ambient conditions in the computing system 102 in which the component exhibited a failure. For example, this can include platform information such as memory DIMM configuration, storage, thermal status of an XPU, memory, etc. In an embodiment, additional telemetry includes reliability, availability and serviceability (RAS) data, resource director technology (RDT) data, and/or Quality of Service (QoS) data, etc. Based at least in part on the visibility level, at block 318 configuration agent 120 applies a selected mask 121 for the unique hashed ID 126 to mask out unnecessary or unauthorized material vintage information.

At block 320, fleet manager 136 retrieves material vintage information (e.g., date tag and version details) based on the hashed ID 126 of component 112 over network 130 from IP vendor 132 or at the datacenter level from hashed IDs 138 previously provided from the IP vendor. The mapping between the hashed ID and the vintage is provided by IP vendor 132. Here, the material vintage lookup can be seen as providing the required material vintage based on the unique hashed ID specific to the component (e.g., IP block/SoC).

Scan operational processing continues with the blocks of FIG. 3B via connector 3B.

Based on an implementation choice, the defect scan test may be initiated immediately by BMC 114 writing to scan MSR 124 and operational control is released to the OS/VMM or the scan configuration information and the material vintage information are saved and the defect scan test is initiated at a preconfigured time in the future. Thus, at block 322, if the scan is to be performed now, at block 324 scan initiator 128 of BMC 114 initiates the scan by signaling defect scanner 122. At block 326, defect scanner 122 performs the defect scan of component 112 using the material vintage information. For cases when the material vintage information is fused within the component (e.g., IP block/SoC), the scan MSR will have the vintage information. Otherwise, the default value of the material vintage information is set to 0s. If the material vintage information is stored at the datacenter level, the vintage is retrieved by fleet manger 136. If the material vintage information is stored at IP vendor 132 site, the vintage is retrieved over the network 130.

Based at least in part on the material vintage information, defect scanner 122 determines an appropriate test pattern to be applied during the scan to detect defects in the component. Components of different vintages may have different test patterns applied to them. Defect scanner 122 identifies details of any defects detected. These details may be denoted scan information results herein.

At block 328, the scan information resulting from performance of the scan may be stored. For example, the scan information results may be stored in log 140. In an embodiment, log 140 comprises a decentralized distributed database (such as a block chain) for record keeping, auditability and/or future data mining. In an embodiment, the scan information results may include one or more of scan interrupts, hashed IDs, hashed ID lookups, material vintage information, material vintage information retrieval, scan results (e.g., defects identified) and remedial actions taken. Based on the stored scan information, fleet manager 136 may determine a response to be taken after one or more defects are detected. In an embodiment, the response includes reducing the functionality of the component or deactivating the component. At block 330, operational control is returned to the OS/VMM from handling of the scan interrupt. If the scan is to be deferred, at block 332 configuration agent 120 saves the scan configuration, sets a timer for a future scan, and returns operational control from the scan interrupt back to the OS/VMM.

While an example manner of implementing the technology described herein is illustrated in FIGS. 1-4, one or more of the elements, processes, and/or devices illustrated in FIGS. 1-4 may be combined, divided, re-arranged, omitted, eliminated, and/or implemented in any other way. Further, the example processor circuitry may be implemented by hardware, software, firmware, and/or any combination of hardware, software, and/or firmware. Thus, for example, any of the example processor circuitry, the example memory circuitry, the example communication interface circuitry, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example processor circuitry, the example memory circuitry, and/or the example communication interface circuitry is/are hereby expressly defined to include a non-transitory computer readable storage device or storage disk such as a memory, a digital versatile disk (DVD), a compact disk (CD), a Blu-ray disk, etc., including the software and/or firmware. Further still, the example circuitry of FIG. 1 may include one or more elements, processes, and/or devices in addition to, or instead of, those illustrated in FIG. 1, and/or may include more than one of any or all the illustrated elements, processes and devices.

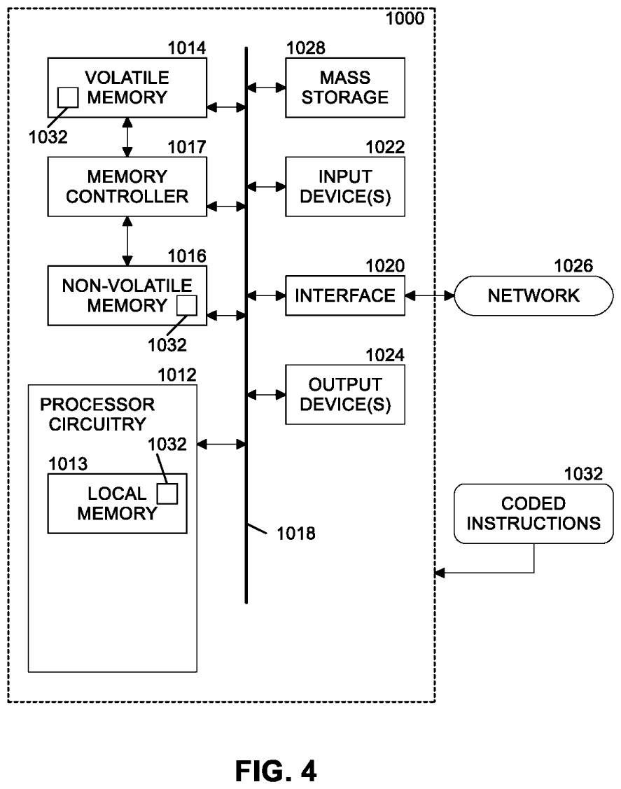

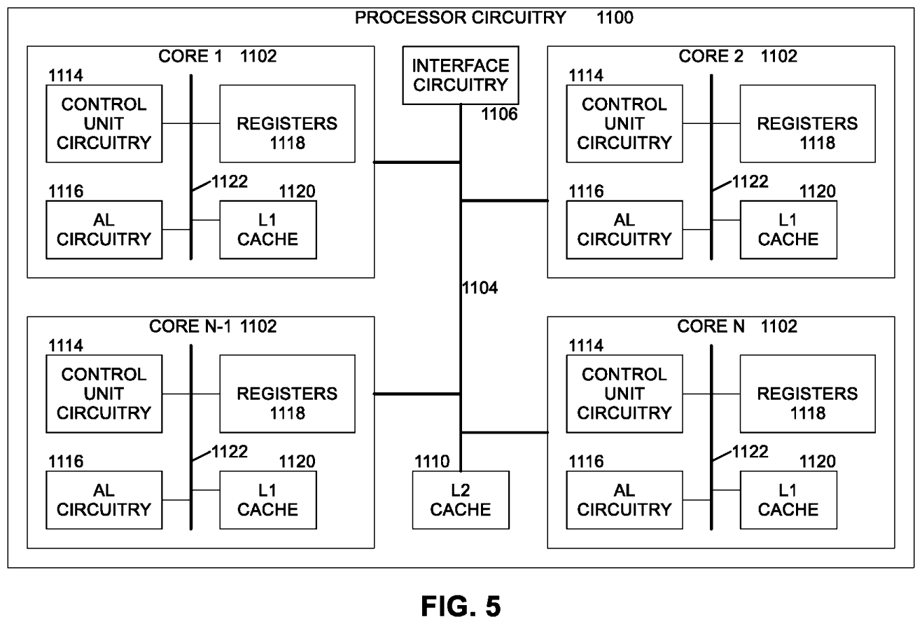

A flowchart representative of example hardware logic circuitry, machine readable instructions, hardware implemented state machines, and/or any combination thereof for implementing the computing system 102 of FIG. 1 is shown in FIGS. 2-3. The machine readable instructions may be one or more executable programs or portion(s) of an executable program for execution by processor circuitry, such as the processor circuitry 712 shown in the example processor platform 700 discussed below in connection with FIG. 4 and/or the example processor circuitry discussed below in connection with FIGS. 5 and/or 6. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 2-3, many other methods of implementing the example computing system 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable media, as used herein, may include machine readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2-3 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a block diagram of an example processor platform 1000 structured to execute and/or instantiate the machine-readable instructions and/or operations of FIGS. 2-3 to implement the computing system 102 of FIG. 1. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements processing capabilities of computing system 102.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1032, which may be implemented by the machine-readable instructions of FIGS. 2-3, may be stored in the mass storage device 1028, in the volatile memory 1014, in the non-volatile memory 1016, and/or on a removable non-transitory computer readable storage medium such as a CD or DVD.

FIG. 5 is a block diagram of an example implementation of the processor circuitry 1012 of FIG. 4. In this example, the processor circuitry 1012 of FIG. 5 is implemented by a microprocessor 1100. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all the machine-readable instructions and/or operations represented by the flowcharts of FIGS. 2-3.

The cores 1102 may communicate by an example bus 1104. In some examples, the bus 1104 may implement a communication bus to effectuate communication associated with one(s) of the cores 1102. For example, the bus 1104 may implement at least one of an Inter-Integrated Circuit (I2C) bus, a Serial Peripheral Interface (SPI) bus, a PCI bus, or a PCIe bus. Additionally or alternatively, the bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2_cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache 1120, and an example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating point operations. In yet other examples, the AL circuitry 1116 may include first AL circuitry that performs integer-based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 5. Alternatively, the registers 1118 may be organized in any other arrangement, format, or structure including distributed throughout the core 1102 to shorten access time. The bus may implement at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general-purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

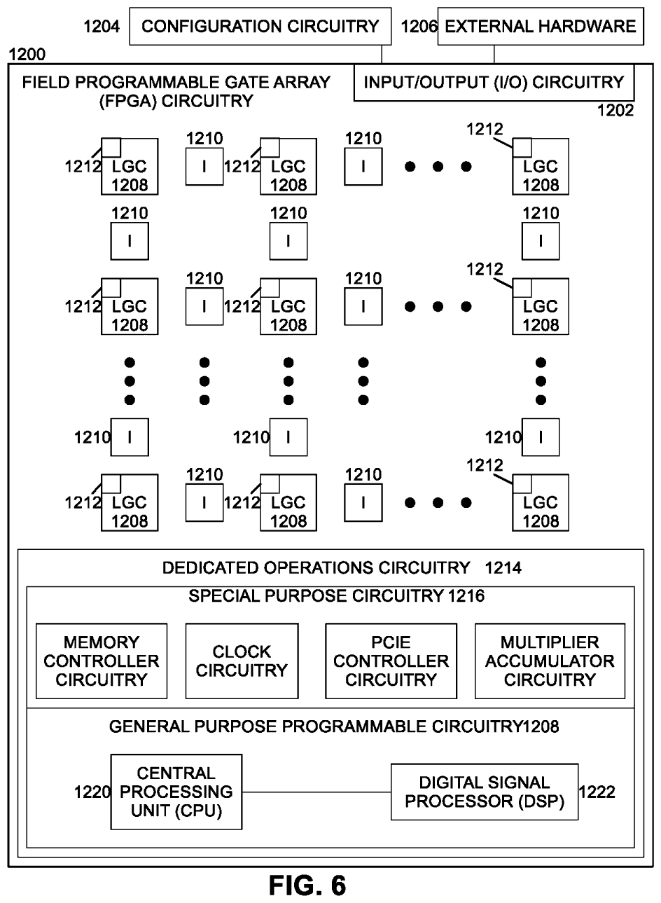

FIG. 6 is a block diagram of another example implementation of the processor circuitry 1012 of FIG. 4. In this example, the processor circuitry 1012 is implemented by FPGA circuitry 1200. The FPGA circuitry 1200 can be used, for example, to perform operations that could otherwise be performed by the example microprocessor 1100 of FIG. 5 executing corresponding machine-readable instructions. However, once configured, the FPGA circuitry 1200 instantiates the machine-readable instructions in hardware and, thus, can often execute the operations faster than they could be performed by a general-purpose microprocessor executing the corresponding software.

More specifically, in contrast to the microprocessor 1100 of FIG. 5 described above (which is a general purpose device that may be programmed to execute some or all of the machine readable instructions represented by the flowcharts of FIGS. 2-3 but whose interconnections and logic circuitry are fixed once fabricated), the FPGA circuitry 1200 of the example of FIG. 6 includes interconnections and logic circuitry that may be configured and/or interconnected in different ways after fabrication to instantiate, for example, some or all of the machine readable instructions represented by the flowcharts of FIGS. 2-3. In particular, the FPGA 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowcharts of FIGS. 2-3. As such, the FPGA circuitry 1200 may be structured to effectively instantiate some or all of the machine-readable instructions of the flowcharts of FIGS. 2-3 as dedicated logic circuits to perform the operations corresponding to those software instructions in a dedicated manner analogous to an ASIC. Therefore, the FPGA circuitry 1200 may perform the operations corresponding to the some or all of the machine-readable instructions of FIGS. 2-3 faster than the general-purpose microprocessor can execute the same.

In the example of FIG. 6, the FPGA circuitry 1200 is structured to be programmed (and/or reprogrammed one or more times) by an end user by a hardware description language (HDL) such as Verilog. The FPGA circuitry 1200 of FIG. 6, includes example input/output (I/O) circuitry 1202 to obtain and/or output data to/from example configuration circuitry 1204 and/or external hardware (e.g., external hardware circuitry) 1206. For example, the configuration circuitry 1204 may implement interface circuitry that may obtain machine readable instructions to configure the FPGA circuitry 1200, or portion(s) thereof. In some such examples, the configuration circuitry 1204 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may implement the microprocessor 1100 of FIG. 5. The FPGA circuitry 1200 also includes an array of example logic gate circuitry 1208, a plurality of example configurable interconnections 1210, and example storage circuitry 1212. The logic gate circuitry 1208 and interconnections 1210 are configurable to instantiate one or more operations that may correspond to at least some of the machine-readable instructions of FIGS. 2-3 and/or other desired operations. The logic gate circuitry 1208 shown in FIG. 6 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 6 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 5 and 6 illustrate two example implementations of the processor circuitry 1012 of FIG. 4, many other approaches are contemplated. For example, as mentioned above, modern FPGA circuitry may include an on-board CPU, such as one or more of the example CPU 1220 of FIG. 6. Therefore, the processor circuitry 1012 of FIG. 4 may additionally be implemented by combining the example microprocessor 1100 of FIG. 5 and the example FPGA circuitry 1200 of FIG. 6. In some such hybrid examples, a first portion of the machine-readable instructions represented by the flowcharts of FIGS. 2-3 may be executed by one or more of the cores 1102 of FIG. 5 and a second portion of the machine-readable instructions represented by the flowcharts of FIGS. 2-3 may be executed by the FPGA circuitry 1200 of FIG. 6.

In some examples, the processor circuitry 1012 of FIG. 4 may be in one or more packages. For example, the processor circuitry 1100 of FIG. 5 and/or the FPGA circuitry 1200 of FIG. 6 may be in one or more packages. In some examples, an XPU may be implemented by the processor circuitry 1012 of FIG. 4, which may be in one or more packages. For example, the XPU may include a CPU in one package, a DSP in another package, a GPU in yet another package, and an FPGA in still yet another package.

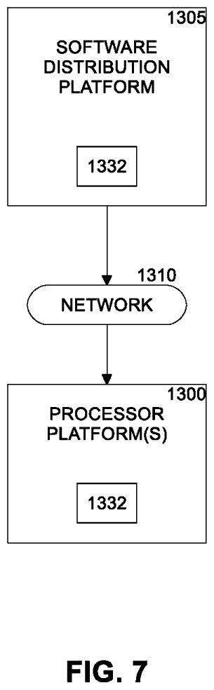

A block diagram illustrating an example software distribution platform 1305 to distribute software such as the example machine readable instructions 1032 of FIG. 4 to hardware devices owned and/or operated by third parties is illustrated in FIG. 7. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 4. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine readable instructions, as described above. The one or more servers of the example software distribution platform 1305 are in communication with a network 1310, which may correspond to any one or more of the Internet and/or any of the example networks, etc., described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1032 from the software distribution platform 1305. For example, the software, which may correspond to the example machine readable instructions described above, may be downloaded to the example processor platform 1300, which is to execute the machine-readable instructions 1032 to implement the methods described above and associated computing system 102. In some examples, one or more servers of the software distribution platform 1305 periodically offer, transmit, and/or force updates to the software (e.g., the example machine readable instructions 1032 of FIG. 4) to ensure improvements, patches, updates, etc., are distributed and applied to the software at the end user devices.

In some examples, an apparatus includes means for processing OS/VMM 108, component 112, and BMC/TEE 114 of FIG. 1. For example, the means for processing may be implemented by processor circuitry, firmware circuitry, etc. In some examples, the processor circuitry may be implemented by machine executable instructions executed by processor circuitry, which may be implemented by the example processor circuitry 1012 of FIG. 4, the example processor circuitry 1100 of FIG. 5, and/or the example Field Programmable Gate Array (FPGA) circuitry 1200 of FIG. 6. In other examples, the processor circuitry is implemented by other hardware logic circuitry, hardware implemented state machines, and/or any other combination of hardware, software, and/or firmware. For example, the processor circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

From the foregoing, it will be appreciated that example systems, methods, apparatus, and articles of manufacture have been disclosed that provide defect scanning of components in a computing system. The disclosed systems, methods, apparatus, and articles of manufacture improve the efficiency of using a computing device by detecting when defects occur in components. The disclosed systems, methods, apparatus, and articles of manufacture are accordingly directed to one or more improvement(s) in the operation of a machine such as a computer or other electronic and/or mechanical device.

Example 1 is a method including detecting a scan interrupt; reading a scan register of a component of a computing system, the scan register including a hashed identifier (ID) of the component; getting material vintage information of the component based at least in part on the hashed ID; and initiating a scan of the component based at least in part on the material vintage information to detect any defects in the component.

In Example 2, the subject matter of Example 1 may optionally include wherein the material vintage information comprises at least one of manufacturing process version, manufacturing bin, and date code of manufacturing of the component. In Example 3, the subject matter of Example 1 may optionally include validating a scan configuration by comparing a first checksum of the scan interrupt with a second checksum of the scan register and setting a failure indicator in the scan register when the first checksum does not match the second checksum. In Example 4, the subject matter of Example 2 may optionally include getting the material vintage information from a vendor of the component based at least in part on the hashed ID. In Example 5, the subject matter of Example 1 may optionally include storing a result of the scan, including any detects detected in the component by performance of the scan, the hashed ID, and the material vintage information in a decentralized database coupled to the computing system. In Example 6, the subject matter of Example 5 may optionally include wherein the decentralized database comprises a block chain. In Example 7, the subject matter of Example 5 may optionally include at least one of reducing functionality of the component and deactivating the component when a defect is detected in the component by performance of the scan. In Example 8, the subject matter of Example 1 may optionally include initiating the scan by one of a baseboard management controller (BMC) and a Trusted Execution Environment (TEE) of the computing system and performing the scan by a defect scanner of the component.

In Example 9, the subject matter of Example 1 may optionally include masking the hashed ID and getting the material vintage information based at least in part on the masked hashed ID. In Example 10, the subject matter of Example 1 may optionally include getting the material vintage information from the scan register. In Example 11, the subject matter of Example 1 may optionally include determining a visibility level of the hashed ID. In Example 12, the subject matter of Example 1 may optionally include determining a test pattern to be applied during performance of the scan based at least in part on the material vintage information.

Example 13 is at least one least one non-transitory machine-readable storage medium comprising instructions that, when executed, cause at least one processor to: detect a scan interrupt; read a scan register of a component of a computing system, the scan register including a hashed identifier (ID) of the component; get material vintage information of the component based at least in part on the hashed ID; and initiate a scan of the component based at least in part on the material vintage information to detect any defects in the component. In Example 14, the subject matter of Example 13 may optionally include instructions that, when executed, cause at least one processor to get the material vintage information from a vendor of the component based at least in part on the hashed ID. In Example 15, the subject matter of Example 13 may optionally include instructions that, when executed, cause at least one processor to get the material vintage information from the scan register. In Example 16, the subject matter of Example 13 may optionally include instructions that, when executed, cause at least one processor to determine a visibility level of the hashed ID. In Example 17, the subject matter of Example 13 may optionally include instructions that, when executed, cause at least one processor to determine a test pattern to be applied during performance of the scan based at least in part on the material vintage information.

Example 18 is an apparatus comprising: a memory to store instructions and a plurality of test patterns; and a processor, coupled to the memory, to execute the instructions to detect a scan interrupt; read a scan register of a component of a computing system, the scan register including a hashed identifier (ID) of the component; get material vintage information of the component based at least in part on the hashed ID; and initiate a scan of the component based at least in part on the material vintage information to detect any defects in the component. In Example 19, the subject matter of Example 18 may optionally include wherein the material vintage information comprises at least one of manufacturing process version, manufacturing bin, and date code of manufacturing of the component. In Example 20, the subject matter of Example 18 may optionally include the processor to get the material vintage information from a vendor of the component based at least in part on the hashed ID. In Example 21, the subject matter of Example 18 may optionally include the processor to store a result of the scan, including any detects detected in the component by performance of the scan, the hashed ID, and the material vintage information in a block chain coupled to the computing system.

Example 21 is an apparatus operative to perform the method of any one of Examples 1 to 12. Example 22 is an apparatus that includes means for performing the method of any one of Examples 1 to 12. Example 23 is an apparatus that includes any combination of modules and/or units and/or logic and/or circuitry and/or means operative to perform the method of any one of Examples 1 to 12. Example 24 is an optionally non-transitory and/or tangible machine-readable medium, which optionally stores or otherwise provides instructions that if and/or when executed by a computer system or other machine are operative to cause the machine to perform the method of any one of Examples 1 to 12.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the examples of this patent.

What is claimed is:

1. An apparatus comprising:
a memory to store instructions and a plurality of test patterns; and
a processor, including a scan register to store a hashed identifier (ID) of a component of a computing system, coupled to the memory, to execute the instructions to
detect a scan interrupt;
read the scan register;
get material vintage information of the component based at least in part on the hashed ID; and
initiate a scan of the component based at least in part on the material vintage information to detect any defects in the component.

2. The apparatus of claim 1, wherein the material vintage information comprises at least one of manufacturing process version, manufacturing bin, and date code of manufacturing of the component.

3. The apparatus of claim 1, comprising the processor to get the material vintage information from a vendor of the component based at least in part on the hashed ID.

4. The apparatus of claim 1, comprising the processor to store a result of the scan, including any detects detected in the component by performance of the scan, the hashed ID, and the material vintage information in a block chain coupled to the computing system.

5. The apparatus of claim 1, wherein the scan register comprises a model specific register (MSR) of the processor.

6. A method comprising:
detecting a scan interrupt;
reading a scan register of a component of a computing system, the scan register including a hashed identifier (ID) of the component;
getting material vintage information of the component based at least in part on the hashed ID; and
initiating a scan of the component based at least in part on the material vintage information to detect any defects in the component.

7. The method of claim 6, wherein the material vintage information comprises at least one of manufacturing process version, manufacturing bin, and date code of manufacturing of the component.

8. The method of claim 6, comprising validating a scan configuration by comparing a first checksum of the scan interrupt with a second checksum of the scan register and setting a failure indicator in the scan register when the first checksum does not match the second checksum.

9. The method of claim 7, comprising getting the material vintage information from a vendor of the component based at least in part on the hashed ID.

10. The method of claim 6, comprising storing a result of the scan, including any detects detected in the component by performance of the scan, the hashed ID, and the material vintage information in a decentralized database coupled to the computing system.

11. The method of claim 10, wherein the decentralized database comprises a block chain.

12. The method of claim 10, comprising at least one of reducing functionality of the component and deactivating the component when a defect is detected in the component by performance of the scan.

13. The method of claim 6, comprising initiating the scan by one of a baseboard management controller (BMC) and a Trusted Execution Environment (TEE) of the computing system and performing the scan by a defect scanner of the component.

14. The method of claim 6, comprising masking the hashed ID and getting the material vintage information based at least in part on the masked hashed ID.

15. The method of claim 6, comprising getting the material vintage information from the scan register.

16. The method of claim 6, comprising determining a visibility level of the hashed ID.

17. The method of claim 6, comprising determining a test pattern to be applied during performance of the scan based at least in part on the material vintage information.

18. At least one least one non-transitory machine-readable storage medium comprising instructions that, when executed, cause at least one processor to:
detect a scan interrupt;
read a scan register of a component of a computing system, the scan register including a hashed identifier (ID) of the component;
get material vintage information of the component based at least in part on the hashed ID; and
initiate a scan of the component based at least in part on the material vintage information to detect any defects in the component.

19. The at least one least one non-transitory machine-readable storage medium of claim 18 comprising instructions that, when executed, cause at least one processor to get the material vintage information from a vendor of the component based at least in part on the hashed ID.

20. The at least one least one non-transitory machine-readable storage medium of claim 18 comprising instructions that, when executed, cause at least one processor to get the material vintage information from the scan register.

21. The at least one least one non-transitory machine-readable storage medium of claim 18 comprising instructions that, when executed, cause at least one processor to determine a visibility level of the hashed ID.

22. The at least one least one non-transitory machine-readable storage medium of claim 18 comprising instructions that, when executed, cause at least one processor to determine a test pattern to be applied during performance of the scan based at least in part on the material vintage information.
